(19) United States
(12) Patent Application Publication
(10) Pub. No.: US 2005/0220404 A1
(43) Pub. Date: Oct. 6, 2005

(54) Optical interconnect module, and ferrule comprising same

(76) Inventors: Alain Flers, Bernard (FR); Gnitaboure Yabre, Le Mans (FR); Bogdan Rosinski, Brest (FR)

Correspondence Address: HARRINGTON & SMITH, LLP, 4 RESEARCH DRIVE, SHELTON, CT, 06484-6212, US

(21) Appl. No.: 10/505,302

(22) PCT Filed: Feb. 19, 2003
(86) PCT No.: PCT/EP03/50023

§ 371 Date: May 9, 2005

(30) Foreign Application Priority Data
Feb. 21, 2002 (FR) 0202249

(51) Int. Cl. G02B 6/32

(52) U.S. Cl. 385/33

(57) ABSTRACT

In order to make an optical interconnection of either two optical fibers to each other or of one optical fiber with an optoelectronic conversion circuit, it is planned to have a module provided with a body or package in which sections of optical fibers are overmolded. The overmolding on the one hand simplifies industrial-scale manufacture and, on the other hand, enables the adoption, for the optical fiber sections, of shapes such as flared shapes and/or lenses enabling an appropriate refocusing or collimation of the light rays conveyed by these optical fibers.

### BACKGROUND OF THE INVENTION

1. Field of the Invention

An object of the present invention is an optical interconnection module and a ferrule comprising such a module, of the type used in optical fiber transmission, especially but not only to connect one end of an optical fiber to an electronic circuit for the detection or emission of light rays.

An optical fiber is used essentially as a means to convey information in the form of light signals that are normally digitized. This means of transportation has the advantage of efficiently resisting noise, especially electromagnetic noise, and furthermore enabling very high data bit rates. However, since processing in present-day computer devices is of the electronic type, it is important to carry out an optoelectronic conversion of the light signals to be processed at input and output of the optical fiber. Furthermore, since the optical fibers may abut one another, it is important to be able to connect them efficiently. Various solutions have been devised to resolve these problems of conversion and/or connection.

2. Description of the Prior Art

Certain solutions have entailed the idea of making harnesses. In these harnesses, an optical fiber or a bundle of optical fibers is provided, fixedly at both ends (or at least at one of its ends), with an optoelectronic conversion device. In this case, the optical fiber delivers electrical signals or electronic signals at one or both ends while it may deliver optical signals at another end. The drawback of this type of solution is, firstly, the cost generated by this integration of means. Secondly, the ease with which the fiber can be handled is thereby greatly reduced. Indeed, it will easily be understood that the length of the fiber cannot be adjusted as easily as desired, especially if it is provided on either side with electronic conversion circuits crimped to the ends of the fibers. In this case, it is not at all possible to lengthen or shorten the fiber. All that can be done is to exchange it for another differently sized harness, which however will also be a high-cost harness. Besides, the presence of the electronic conversion circuit leads to the making of a joining piece at the end of the optical fiber. The bulkiness of this joining piece is inconvenient if the fiber has to be threaded into narrow holes to conduct the signals from one place to another.

Furthermore, the mode of transmission in optical fibers may depend on whether the nature of the fiber is single-mode or multimode and/or on the device for the injection of light rays into the fiber. Then, during the injection or extraction of the light rays from an optical fiber, it is important to concentrate these rays to the maximum extent on the core of the fiber whose diameter is about 10 micrometers for a single-mode fiber (whereas it is about 50 or 62.5 micrometers for multimode fibers). In practice, there is then a loss in volume, with the light rays dispersing in a wide-aperture cone, typically in the range of 20 degrees. The only light rays used are those located in a solid angle beneath which, a sensitive zone of an optoelectronic detector is perceived from the core of an optical fiber or vice versa. This division in the solid angle reduces the power injected or taken. Considerable losses are thus encountered during the optoelectronic conversion, or even during the connection of several optical fibers abutting one another.

To resolve all these problems, there are known ways, especially described in the document U.S. Pat. No. 5,168,537, for placing focusing lenses in the path of the light rays so as to concentrate their energy on the useful zone, namely the core of the fiber or a sensitive zone of the detector. The positioning of these focusing lenses is, however, the source of a drawback at the industrial level because it necessitates operations to manipulate microscopic objects for which, furthermore, the positioning must be rigorously precise, given the tolerance values referred to here above. Consequently, the devices presented in the above document can be used only in the laboratory and not on a large-scale.

In the invention, to resolve the problem, it has been chosen to manufacture one-piece ferrules by overmolding. In practice then, the invention uses a package in which straight or curved grooves are traced and then filled with an overmolding material. As the case may be, the package is formed out of two half shells that are assembled around the overmolding material. It will be shown that, with this technique and with the shape of the grooves, it can be chosen to form lenses more easily. The grooves will be V-grooves, circular cylindrical, circular semi-cylindrical, or the like, and their direction will be straight or curved. The lenses are obtained either by the placing, at the ends of the ferrule, of an excess of overmolding material that naturally adopts a lens shape with a focusing power, or by making grooves whose transversal profile develops especially in a cone shape at the ends of an optical guide section thus made in the package. In this case, flared features are made at low cost, providing for focal matching either at the connection between two optical fibers or at the connection between a transportation optical fiber and an optoelectronic conversion circuit.

### SUMMARY OF THE INVENTION

An object of the invention therefore is an optical interconnection module comprising a package provided with at least one optical section interposed between an input optical port of the module and an output optical port of the module, characterized in that the optical section is overmolded in the package and forms an optical waveguide, in that the optical fiber section comprises at least one flared cone getting enlarged at one end of the section and forming an optical output section, and in that the optical section comprises an end lens.

An object of the invention is also a ferrule provided with such a module.

### BRIEF DESCRIPTION OF THE DRAWINGS

The invention will be understood more clearly from the following description and the accompanying figures. These figures are given purely by way of an indication and in no way restrict the scope of the invention. Of these figures:

FIGS. 1a and 1b show longitudinal sectional views, along two perpendicular planes, of the optical module of the invention;

FIG. 2 shows a sectional view of an example of an integration of a module according to the invention in a complete optoelectronic conversion ferrule and;

FIG. 3 is a sectional view showing an alternative embodiment of the integration of FIG. 2.

### MORE DETAILED DESCRIPTION

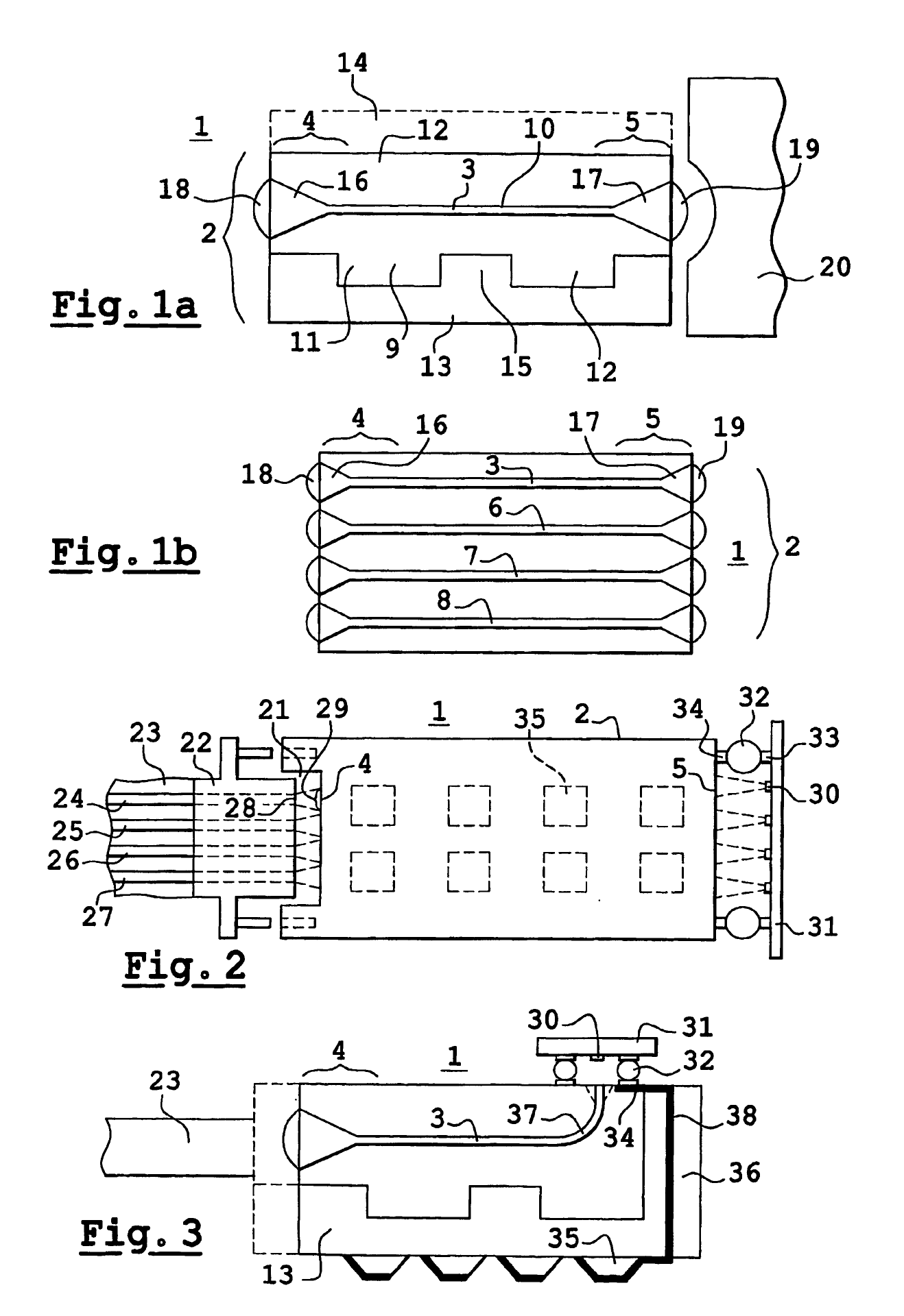

FIGS. 1a and 1b show an optical module 1 according to the invention. This module 1 has a package 2 provided with at least one optical section 3, comprising an optical fiber in one example, and more generally light waveguides. The waveguide 3 is interposed between an input optical port 4 and an output optical port 5 of the module. In FIG. 1b, it can be seen that several optical section such as 3 and 6 to 8 are active side by side, preferably in parallel to one another, in the package 2. On the whole, the package has a parallelepiped shape.

According to a main characteristic of the invention, the package 2 is formed by a base made out of at least one first material 9 (FIG. 1a) in which the waveguide sections 3 or 6 to 8 are overmolded. The waveguide sections are made of another material. In practice the material 9 of the base could preferably be a plastic material with an amorphous structure for example made of a same material (COC or cyclic oleofin copolymer) as the material constituting waveguide sections. At least the material 10 will be transparent to the light rays. Preferably, the material 9 will also be transparent to light rays and will possess a refraction index, n2 smaller than a refraction index n1 of the material 10 forming the waveguide. This mode of action ensures that the overmolding operation is appropriate (the materials having same mechanical properties), while at the same time ensuring the waveguide character of the sections 3 or 6 to 8 made of the material 10. As a variant, it can be planned that the material 9 of the base will be a ceramic and that the material 10 of the waveguides 3 or 6 to 8 will be molten glass.

The overmolding approach thus presented furthermore makes it possible, using techniques of microsculpture, to impose a set of particularly useful shapes for the waveguide 3, or for the sections 6 to 8. The micro-structuring techniques may be stamping or heat embossing techniques, or else techniques of photolithography with chemical etching or again techniques of laser etching. The aim is to make grooves that are capable of receiving the overmolding material 10. The overmolding material itself may be put in place by micro-injection techniques, the conduit made in the material 9 possessing an inlet and an exit and thus being suitable for injection.

As a variant, the package 2 made of material 9 may comprise a body formed by a base 11 and a lid 12. The base and the lid may both be made of a same material, for example a transparent material with a refraction coefficient n2 lower than the coefficient of refraction of the material 9 of the waveguide 3. However, the lid 12 could also be made with a gel having an appropriate refraction index.

Within the framework of such a solution, preferably first of all a pedestal 13 is made using a material capable of easily accepting the material 9 of the base 11. For example, the material of the pedestal 13, in the context of a plastic embodiment, will be a PBT (polybutylene terephtalate), a polyimide, or a crystalline or semicrystalline polymer possessing good mechanical behavior such as liquid-crystal polymers (LCP). These materials furthermore have the advantage of standing up to processing at high temperatures, the justification of which shall be seen further below. If necessary, in this case, the lid 12 may itself be mounted in a cap 14 having a same function and a same nature as the pedestal 13 with respect to the base 11. In particular, the base 13 will be provided with relief features such as 15, with sharp edges in the form of grooves or pads, enabling the material 9 of the base 11 to grip this pedestal 13 in an efficient and industrially lasting way. The same action will be taken, if necessary, for the lid 13 with respect to the cap 14.

The base 11 is thus overmolded on the pedestal 13. After this preferred overmolding, the base 11 is polymerized and then sculpted, by etching or otherwise, in order to make conduits therein, especially in the form of grooves designed to subsequently serve as light waveguides. These sculpted conduits are then filled in turn with an overmolding material 10 designed to form light waveguides 3. Then the lid 12 is put into place and the material 10 is polymerized so as to be made rigid. If necessary, the polymerization is done prior to the positioning of the lid 12, it being possible to true the surface of the unit thus made before the positioning of the lid 12. In this case, the lid itself is not necessarily provided with grooves.

According to a particularly promising improvement of the invention, the optical fiber sections 3 are provided, preferably in the input port 4 and in the output port 5, but at least in one of them, with flared cones such as 16 and 17 respectively. They are even preferably surmounted with lenses such as 18 and 19. It is furthermore possible to make the sections without flared portions, but with lenses just as it is possible to make the sections with flared portions but without the lenses. The flared portions have an effect of improving the optical transfer. The lenses 18 and 19 have a focusing or collimation effect that shall be explained further below. Preferably, the lenses are obtained by the positioning of an overmolding mold 20 when the waveguides are overmolded 3.

Preferably, the lenses are thus made of a same material as the material 10 of the waveguides 3, and at the same time as these waveguides 3. The flared portions 16 and 17 are such that the waveguide section 3, made of optical fiber, has a smaller diameter or a smaller section on the length of the package than the diameter or section at the entry to the input port 4 or at the exit from the output port 5. The shape of the section of the waveguide in the longitudinal part may be circular or polygonal, preferably square or rectangular in this case. The length of each of the flared portions 16 and 17 is about one-tenth of the length of the sections 3.

FIG. 2 shows that the package 2 is more complete, especially that the input port 4 has a receptacle 21 to receive a standardized joining piece 22 mounted on a bundle 23 of optical fibers 24 to 27. It forms a ferrule provided with the module of the FIGS. 1a and 1b. The number of optical fibers in the bundle 23 is of course preferably the same as that of the optical fiber sections in the ferrule. According to the invention, each of the emitting or receiving ends such as 28 of the optical fibers of the bundle 23 then respectively perceives a field 29 formed by a lens input face such as 18. This field 29 is greater than these ends 28. As a consequence, the energy transferred to or from the fiber section 3 is far more efficient.

At the other end, the package 2 of the ferrule 1 comprises the output port 5 also provided with lenses 19. These lenses are placed here so as to be facing integrated circuits 30 for the detection or emission of light rays. These integrated circuits 30, which are individualized and are equal in number to the number of sections 3, are themselves placed on a driving integrated circuit 31.

According to one characteristic of this assembly, the integrated circuits 30 are placed in a very rigorously precise way on the driving circuit 31 through mounting by reflow soldering of solder beads: surface tensions appear in these solder beads at the time of the soldering and enable the perfect positioning (with a tolerance of less than one micrometer) of these integrated circuits 30 at chosen places in this integrated circuit 31. The driving circuit 31 is itself mounted on the package 2 by reflow of soldering beads 32 enable a precise positioning of the connection zones 33 of the circuit 31 relative to metallised zones 34 formed on the package 2. In particular, the pedestal 13 or the cap 14, which are made of materials that withstand very high temperatures, enable these reflow operations. Thus a result is obtained wherein the ferrule 1 provides a low-cost optoelectronic connection between the circuits 30 and 31 and the bundle 23 of optical fibers.

Electronic tracks enable the electrical connection of the circuits 31 and the circuits 30 to a main printed circuit, by means of solder beads 32, comprising pads such as 35 (FIG. 3) located beneath one face of the package, especially beneath the lower face of the pedestal 13.

FIG. 3 shows an alternative embodiment of the ferrule of FIG. 2. In FIG. 3, the pedestal 13 has a right end foot 36 opposite the input port 4. This foot 36 is of great height and rises towards a lid (not shown) of the ferrule. FIG. 3 is presented along the plane perpendicular to the plane of FIG. 2. In this FIG. 3, the bundle 23 is seen along the edge. The sections 3 therein have the particular feature of having an elbow 37 by which it is possible to ensure that the output port 5 is not in a rectilinear alignment with the input port 4 along the section 3.

Such an elbow 37 fulfils the same role as the mirror of the prior art 24 referred to, but at lower cost. With such an elbow 37, the circuit 30, and the circuit 31 can again be in a plane of the printed circuit (not shown) that bears the ferrule 1 (or in a parallel plane). In the first case, which is not shown, the elbow 37 will be oriented toward the plane of the pads 35. The pedestal 13 could be filled at the position of the pads to let out the material 9 of the base 11 and the material 10 of the guide 3.

In the case of these elbows 37, the embodiment using overmolding may comprise the making of several vertical slices in which grooves are made, having an end in the shape of a cross-head (the end may or may not be provided, at the end of the cross-head with a flared portion 17). The different slices are then attached to one another and the material that has to constitute the sections 3 is injected into the galleries thus formed by the joining of slices against one another. As a variant, the slices are provided with a grooves on only one side, and these grooves are filled when flat by overmolding of the material 10. Then the slices are assembled against one another, after truing if necessary. This embodiment then makes it possible to present the integrated circuit 31 (provided with its emitting or detecting integrated circuits 30) parallel to a plane of a general printed circuit on which the ferrule 1 is positioned. To this end, metallised connections 38 coming from the metallizations 34 made in the package 2 run along the right foot 36, up to the pads 35. The metallizations of the pads 35 enable the electrical connection of the circuit 31 with a reception printed circuit as well as the holding of the ferrule 1, by soldering, to this reception printed circuit.

It would furthermore be possible to form the lenses 18 or 19 out of a material with a refraction index that is different from that of the material used to form the sections 3 and the flared portions 16 and 17. However, preferably, a same material will be used, for reasons of simplification of manufacture.

1. Optical interconnection module comprising a package provided with at least one optical section interposed between an input optical port of the module and an output optical port of the module, characterized in that the optical section is overmolded in the package and forms an optical waveguide, in that the optical fiber section comprises at least one flared cone getting enlarged at one end of the section and forming an optical output section, and in that the optical section comprises an end lens.

2. A module according to claim 1, characterized in that the lens is formed by overmolding.

3. A module according to claim 1, characterized in that the package is made of a material that has an optical refraction index lower than an optical refraction index of an overmolded material forming the optical section.

4. A module according to claim 1, characterized in that the lens is made of a same material as that of the optical section.

5. A module according to claim 1, characterized in that the package comprises a polymer material with efficient thermal behavior such as, for example, an LCP, or a polyimide.

6. A module according to claim 1, characterized in that the package is metallized.

7. A module according to claim 1, characterized in that the package has a pedestal with gripping grooves.

8. A module according to claim 1, characterized in that the overmolded optical section is curved to lead into a plane.

9. An optical ferrule comprising a module according to claim 1, characterized in that the input optical port has a standardized receptacle.

10. An optical ferrule comprising a module according to claim 1, characterized in that it comprises an electronic integrated circuit for the detection or emission of light rays, the integrated circuit being mounted by reflow soldering of solder beads on the package.
